(19) United States
(12) Patent Application Publication
(10) Pub. No.: US 2026/0054562 A1
(43) Pub. Date: Feb. 26, 2026

(54) WHEEL MODULE AND AUTOMOTIVE VEHICLE COMPRISING SAME

(71) Applicant: HL MANDO CORPORATION, Pyeongtaek-si (KR)

(72) Inventors: Kwan Tae PARK, Pyeongtaek-si (KR); Seung Hyun JEONG, Pyeongtaek-si (KR)

(73) Assignee: HL MANDO CORPORATION, Pyeongtaek-si (KR)

(21) Appl. No.: 19/371,354

(22) Filed: Oct. 28, 2025

Related U.S. Application Data
(63) Continuation of application No. PCT/KR2024/001316, filed on Jan. 29, 2024.

(30) Foreign Application Priority Data
Aug. 30, 2023 (KR) 10-2023-0114566

(51) Int. Cl. B60K 7/00; B60T 1/06; B62D 5/04; B62D 7/18

(52) U.S. Cl. CPC B60K 7/0007; B60T 1/06; B62D 5/0418; B60K 2007/0038; B60K 2007/0092; B62D 7/18

(57) ABSTRACT

The present embodiments provide a wheel module and an automotive vehicle comprising same, the wheel module comprising: a wheel assembly comprising a road wheel, a driving motor, and a brake; a frame unit comprising a lower arm which couples to a vehicle body, a knuckle to which the wheel assembly is coupled, and which is rotatably coupled to the lower arm, and a suspension; and a steering motor which couples to the vehicle body and rotates the frame unit.

### CROSS-REFERENCE TO RELATED APPLICATIONS

The present application is a continuation of International Patent Application No. PCT/KR2024/001316 filed on Jan. 29, 2024, which is based upon and claims the benefit of priority to Korean Patent Application No. 10-2023-0114566 filed on Aug. 30, 2023. The disclosures of the above-listed applications are hereby incorporated by reference herein in their entirety.

### TECHNICAL FIELD

The present embodiments relate to a wheel module and a vehicle including the same, and more specifically, to a wheel module capable of a compact structural design through optimization of the arrangement of components that efficiently utilizes a space within a road wheel and a vehicle body, and a vehicle including the same.

### BACKGROUND ART

In general, vehicles are equipped with a drive system in which power generated from an engine is transmitted to the road wheels through power transmission devices such as a crankshaft and a transmission to perform driving, a steering system to control the direction of travel of the vehicle, a braking system to control the speed of the vehicle, and a suspension system to absorb shock from the road surface caused by driving.

In addition, electric vehicles that use electric motors instead of engines have been developed and used recently, and in-wheel motor systems that mount electric motors on road wheels are also being developed.

The in-wheel motor system has recently been developed into a wheel module that incorporates the steering system, braking system, and suspension system in a single road wheel, and this has the advantage of allowing for the utilization of space within the vehicle as there is no need for a power transmission structure from the engine to the road wheel as is found in existing vehicles.

However, since each road wheel is equipped with the steering system, braking system, and suspension system, efficient structural design and component arrangement are required.

### DETAILED DESCRIPTION OF THE INVENTION

### Technical Problem

The present embodiments have been derived from the background described above, and relate to a wheel module capable of a compact structural design through optimization of component arrangement that efficiently utilizes a space within a road wheel and a vehicle body, and to a vehicle including the same.

### Technical Solution

According to the present embodiments, there is provided a wheel module including: a wheel assembly including a road wheel, a drive motor, and a brake; a frame portion including a lower arm coupled to a vehicle body, a knuckle to which the wheel assembly is coupled and which is rotatably coupled to the lower arm, and a suspension; and a steering motor coupled to the vehicle body and rotating the frame portion.

In addition, according to the present embodiments, there is provided a vehicle including: a wheel module including a wheel assembly including a road wheel, a drive motor, and a brake, a frame portion including a lower arm coupled to a vehicle body, a knuckle to which the wheel assembly is coupled and which is rotatably coupled to the lower arm, and a suspension, and a steering motor coupled to the vehicle body and rotating the frame portion.

### Advantageous Effects

According to these embodiments, a compact structural design is possible through optimization of component arrangement that efficiently utilizes the space within the road wheel and vehicle body.

### BRIEF DESCRIPTION OF THE DRAWINGS

FIG. 1 is an exploded perspective view of a wheel module according to the present embodiments;

FIG. 2 is a perspective view of the wheel module according to the present embodiments;

FIG. 3 is a cross-sectional view of a part of the wheel module according to the present embodiments;

FIG. 4 is an exploded perspective view of a part of the wheel module according to the present embodiments;

FIG. 5 is a cross-sectional view of a part of the wheel module according to the present embodiments; and

FIG. 6 is a perspective view of a part of the wheel module according to the present embodiments.

### MODE FOR CARRYING OUT THE INVENTION

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

When it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even when a relevant description is not specified. Further, the term “may” fully encompass all the meanings of the term “can”.

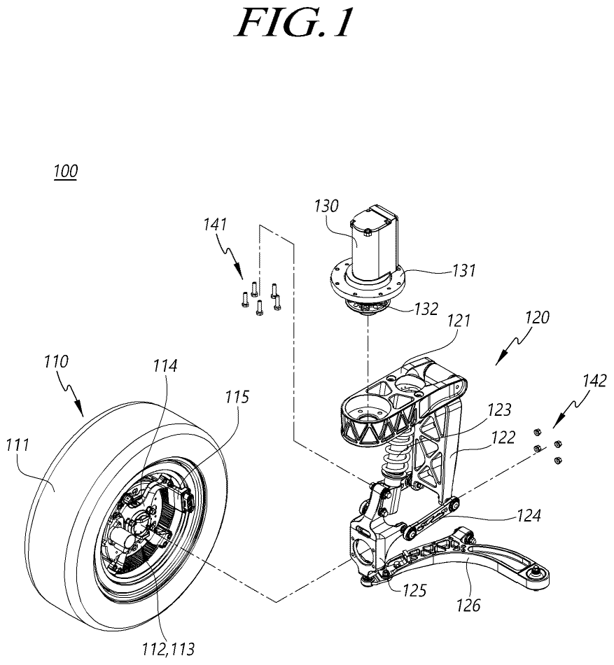

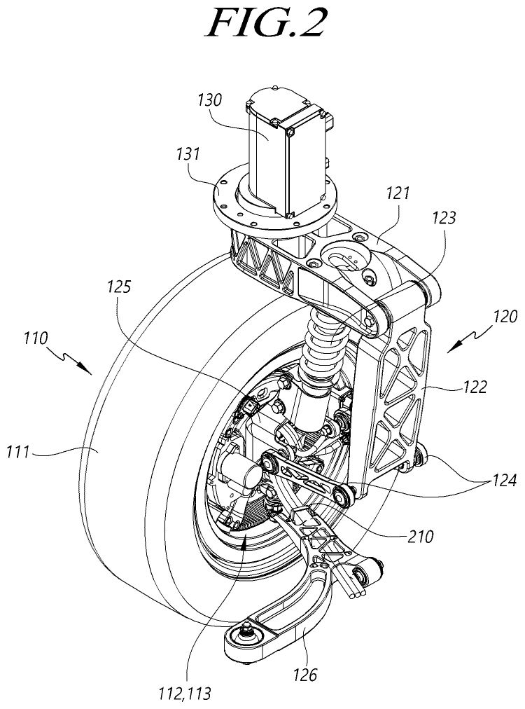

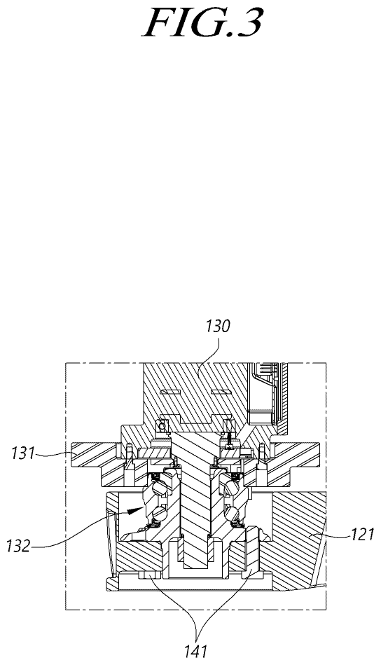

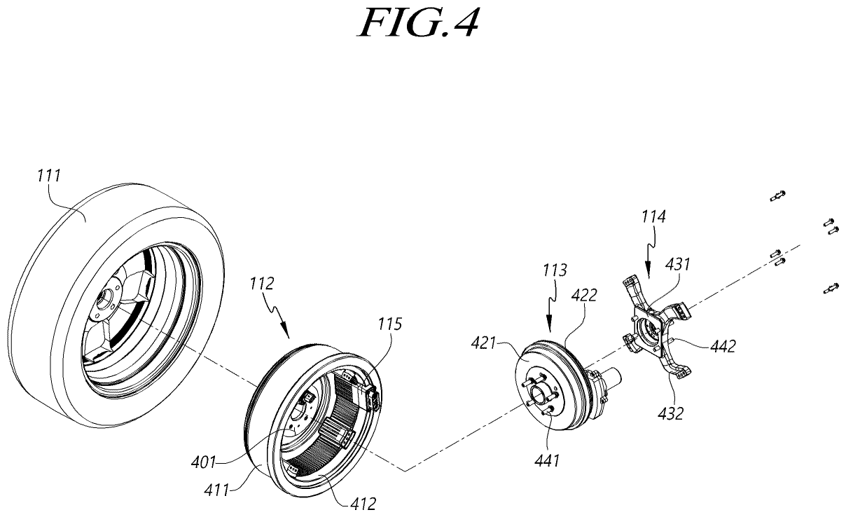

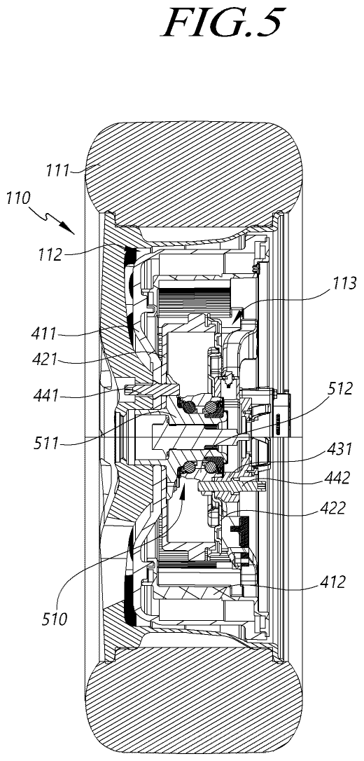

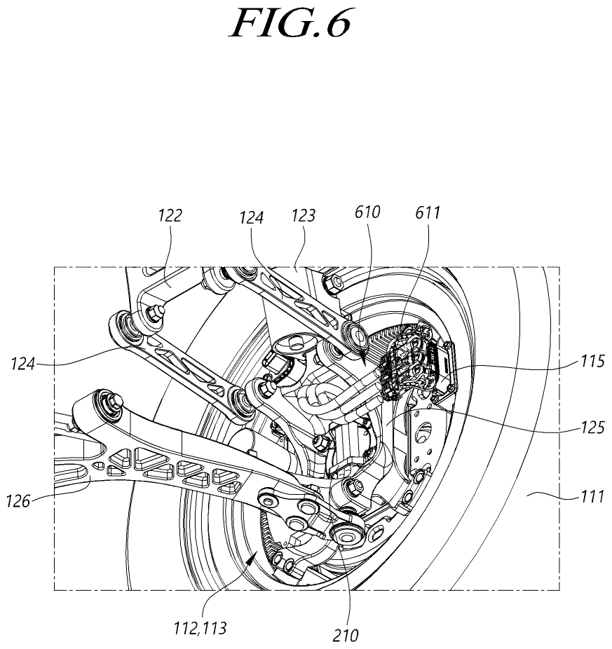

FIG. 1 is an exploded perspective view of a wheel module according to the present embodiments, FIG. 2 is a perspective view of the wheel module according to the present embodiments, FIG. 3 is a cross-sectional view of a part of the wheel module according to the present embodiments, FIG. 4 is an exploded perspective view of a part of the wheel module according to the present embodiments, FIG. 5 is a cross-sectional view of a part of the wheel module according to the present embodiments, and FIG. 6 is a perspective view of a part of the wheel module according to the present embodiments.

According to the present embodiments, a wheel module 100 may be provided, which includes a wheel assembly 110 including a road wheel 111, a drive motor 112, and a brake 113, a frame portion 120 including a lower arm 126 coupled to a vehicle body, a knuckle 125 to which the wheel assembly 110 is coupled and which is rotatably coupled to the lower arm 126, a suspension 123, and a steering motor 130 coupled to the vehicle body and rotating the frame portion 120. In addition, a vehicle including the wheel module 100 according to the present embodiments may be provided.

Referring to FIGS. 1 and 2, the wheel module 100 according to the present embodiments includes the wheel assembly 110, the frame portion 120, and the steering motor 130, and the wheel assembly 110 includes the road wheel 111, the drive motor 112, and the brake 113.

The frame portion 120 includes the lower arm 126, the knuckle 125, and the suspension 123, and the wheel assembly 110 rotates and steering is performed by the torque provided to the frame portion 120 by the steering motor 130.

The drive motor 112 and the brake 113 directly generate driving force to rotate the road wheel 111 and braking force to stop the road wheel 111, respectively, to the road wheel 111. In addition, the suspension 123 absorbs shock from the ground to improve riding comfort.

In one embodiment, the knuckle 125 is coupled to the lower arm 126 by a ball joint. The ball joint coupling the knuckle 125 and the lower arm 126 is provided coaxially with the rotation axis of the steering motor 130, so that the knuckle 125 is rotated relative to the lower arm 126 by the torque of the steering motor 130.

Accordingly, the wheel assembly 110 coupled to the knuckle 125 rotates and steering is performed. As illustrated in the drawing, the lower arm 126 may be coupled to the knuckle 125 at one end by a ball joint and the other end may be coupled to the vehicle body by a ball joint.

The steering motor 130 is coupled to the vehicle body and provides torque to rotate the frame portion 120. That is, if the wheel assembly 110 rotates and steering is performed, the steering motor 130 is coupled to the vehicle body and fixed.

According to one embodiment, the steering motor 130 may be provided with a coupling bracket 131 to which the vehicle body is coupled. The coupling bracket 131 is coupled and fixed to the vehicle body, and the wheel assembly 110 is rotated and steering is performed by torque provided by the steering motor 130 fixed to the vehicle body by the coupling bracket 131.

According to one embodiment, the wheel module 100 according to the present embodiments is provided in a state in which the wheel assembly 110, the frame portion 120, and the steering motor 130 are coupled (see FIG. 2), and the wheel module 100 may be assembled to a vehicle body in a manner in which the steering motor 130 is combined to the vehicle body frame in a state of being coupled.

The wheel assembly 110 includes the road wheel 111, the drive motor 112, and the brake 113. As will be described in detail later, since the drive motor 112 and the brake 113 are provided inside a rim of the road wheel 111, a compact component arrangement design that reduces the overall volume of the wheel module 100 according to the present embodiments is possible.

Accordingly, the space occupied by the wheel module 100 according to the present embodiments in the vehicle body is reduced, and the degree of freedom in vehicle design is improved.

In one embodiment, the frame portion 120 may include an upper frame 121 to which a steering motor 130 is coupled, a lower frame 122 hinge-coupled to the upper frame 121, and an upper arm 124 having both ends hinge-coupled to the knuckle 125 and the lower frame 122.

The upper frame 121, lower frame 122, and upper arm 124 may be hinge-coupled together in an approximate “U” shape as illustrated in the drawings.

In one embodiment, the suspension 123 may be connected at both ends to the knuckle 125 and the upper frame 121. That is, the upper frame 121 and the knuckle 125 are connected to the suspension 123, and the lower frame 122 and the upper arm 124.

The lower frame 122 and the upper arm 124 are connected to the upper frame 121 and the knuckle 125 through a hinge coupling, so that the suspension 123 contracts and may easily absorb shock from the ground.

Referring to FIGS. 1 and 3, according to one embodiment, the steering motor 130 may be coupled to the upper frame 121 via a hub bearing 132. According to one embodiment, a first coupling member 141 may be provided that couples the hub bearing 132 and the upper frame 121.

An inner ring of the hub bearing 132 may be coupled to the upper frame 121 by the first coupling member 141, and an outer ring of the hub bearing 132 may be coupled to the coupling bracket 131 coupled to the steering motor 130. The first coupling member 141 may be a bolt as illustrated in the drawing.

According to one embodiment, the wheel module 100 may be assembled to the vehicle body by first coupling the steering motor 130 to which the hub bearing 132 is coupled to the vehicle body frame, and then coupling the upper frame 121 to the hub bearing 132 using the first coupling member 141.

Referring to FIGS. 1 and 6, according to one embodiment, a second coupling member 142 may be provided to couple the wheel assembly 110 and the knuckle 125.

As described in detail later, the wheel assembly 110 is provided with a fourth coupling member 442 that couples a back plate 422, a bracket 114, and an outer ring 512 of a bearing 510. The rear end of the fourth coupling member 442 is provided to penetrate the knuckle 125, and the second coupling member 142 may be coupled to the fourth coupling member 442, so that the wheel assembly 110 and the knuckle 125 may be coupled. As illustrated in the drawing, the second coupling member 142 may be a nut coupled to the fourth coupling member 442.

Referring to FIGS. 4 and 5, according to one embodiment, the drive motor 112 may include a rotor 411 coupled to the inside of the rim of the road wheel 111, and a stator 412 coupled to the knuckle 125.

As described in detail later, the rotor 411 may be coupled to the rim of the road wheel 111 by the third coupling member 441, and the stator 412 may be coupled to the knuckle 125 via the bracket 114. Therefore, the road wheel 111 is rotated together with the rotor 411 by the operation of the drive motor 112. The drive motor 112 is an external rotation motor in which the rotor 411 is provided on the outside of the stator 412 and coupled to the road wheel 111. The external rotation motor has a greater number of permanent magnets than an internal rotation motor, and thus has the advantage of higher output density.

In addition, as will be described later, there is an advantage in that a compact structural design is possible by using an accommodation space 401 formed at the central portion of the stator 412.

According to one embodiment, an axially open accommodation space 401 may be formed at the central portion of the stator 412, and the brake 113 may be accommodated in the accommodation space 401.

Since the drive motor 112 is an external rotation motor with the rotor 411 positioned on the outside and the stator 412 positioned on the inside, the accommodation space 401 may be formed in the central portion of the stator 412 to receive the brake 113. The brake 113 may apply braking force to the rotor 411.

In one embodiment, the brake 113 may be a drum brake. Commonly used brakes include drum brakes and disc brakes. The disc brakes generally have higher braking power, but the caliper provided in the disc brake interferes with the space utilization of the wheel module.

Therefore, by using the drum brake 113 as the brake 113 provided in the wheel module 100 according to the present embodiments, a compact structural design is possible by settling the brake 113 in the accommodation space of the stator 412. As illustrated in FIG. 5, since both the drive motor 112 and the brake 113 are settling in the accommodation space 401, the space occupied by the wheel assembly 110 is minimized.

In one embodiment, the brake 113 may include a drum 421 that rotates integrally with the rotor 411 and the back plate 422 coupled to the stator 412.

The drum 421 is coupled to the rotor 411 by a third coupling member 441 to be described later and rotates together, and the back plate 422 is coupled to the stator 412 by a fourth coupling member 442 to be described later. A brake shoe that comes into contact with the drum 421 and generates frictional force is provided inside the brake 113, but is omitted in FIG. 5 for convenience of illustration.

In one embodiment, the wheel assembly 110 may further include the bracket 114 that covers the accommodation space 401 and is coupled to the stator 412, the back plate 422, and the knuckle. The drive motor 112 and the brake 113 accommodated in the accommodation space 401 are fixed to the road wheel 111 by the bracket 114.

In one embodiment, the bracket 114 may include a body portion 431 coupled with the knuckle 125, and a coupling portion 432 extending from the body portion 431 and coupled to the stator 412. The body portion 431 may be coupled to the knuckle 125 by a second coupling member 142 and a fourth coupling member 442, and the coupling portion 432 may be coupled to the stator 412 by a bolt.

The coupling portion 432 is formed to extend radially from the body portion 431, and four coupling portions 432 may be provided as illustrated in the drawings.

Referring to FIG. 5, according to one embodiment, the wheel assembly 110 may include a bearing 510 including the road wheel 111, an inner ring 511 to which the rotor 411 of the drive motor 112 and the brake 113 and the drum 421 are coupled, and an outer ring 512 to which the back plate 422 of the brake 113 and the bracket 114 are coupled.

FIG. 5 is a cross-sectional view of the wheel assembly 110 along line A-A′. The road wheel 111, the rotor 411, and the drum 421 are coupled to the inner ring 511 of the bearing 510 and rotate. In addition, the back plate 422 and the bracket 114 are coupled to the outer ring 512 of the bearing 510.

In one embodiment, the third coupling member 441 may be provided that couples the road wheel 111, the rotor 411 of the drive motor 112, the drum 421 of the brake 113, and the inner ring 511 of the bearing 510.

The third coupling member 441 may be provided to penetrate the rim, rotor 411, drum 421, and inner ring 511 of the road wheel 111 as illustrated in the drawing. By the third coupling member 441, the torque of the drive motor 112 is transmitted to the road wheel 111 and drum 421 to rotate them.

In one embodiment, the fourth coupling member 442 may be provided that couples the back plate 422 of the brake 113, the bracket 114, and the outer ring 512 of the bearing 510. The fourth coupling member 442 may be provided to penetrate the back plate 422, the body portion 431 of the bracket 114, and the outer ring 512 as illustrated in the drawing.

Moreover, as described above, the rear end of the fourth coupling member 442 is provided to protrude from the rear surface of the body portion 431, so that the second coupling member 142 is connected to the rear end of the fourth coupling member 442 penetrating the knuckle 125, and the wheel assembly 110 and the knuckle 125 may be connected.

Meanwhile, referring to FIG. 2 and FIG. 6, a coupling hole 115 may be formed in the stator 412 to which a connector 611 of a wire assembly 610 for supplying power to the stator 412 is coupled. The wire assembly 610 includes a wire and the connector 611 that are connected to a power supply and an electronic control device mounted on a vehicle. The connector 611 may be coupled to the coupling hole 115 and supply three-phase power to the stator 412.

In one embodiment, a guide member 210 may be provided to guide the wire path of the wire assembly 610. The guide member 210 guides the wire path to prevent interference between the wire and surrounding components if steering of the wheel module 100 according to the present embodiments is performed.

For example, the guide member 210 may be formed in a U-shape to guide the path by pressing the wire against the upper surface of the lower arm 126, or guide the path by pressing the wire against the rear surface of the knuckle 125 (see FIG. 6).

According to a wheel module having such a structure and a vehicle including the same, a compact structural design is possible through optimization of component arrangement that efficiently utilizes the space within the road wheel and vehicle body.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded the widest scope consistent with the claims.

1. A wheel module, comprising:
a wheel assembly including a road wheel, a drive motor, and a brake;
a frame including a lower arm, a knuckle, and a suspension, wherein the lower arm is configured to be coupled to a vehicle body, the wheel assembly is coupled to the knuckle, and the knuckle is rotatably coupled to the lower arm; and
a steering motor configured to be coupled to the vehicle body, wherein the steering motor is configured to rotate the frame.

2. The wheel module of claim 1, further comprising: a ball joint that couples the knuckle to the lower arm.

3. The wheel module of claim 1, wherein the steering motor comprises a coupling bracket coupled to the vehicle body.

4. The wheel module of claim 1, wherein the frame includes an upper frame to which the steering motor is coupled, a lower frame hinge-coupled to the upper frame, and an upper arm having a first end hinge-coupled to the knuckle and a second end hinge-coupled to the lower frame.

5. The wheel module of claim 4, wherein the suspension has a first end connected to the knuckle and a second end connected to the upper frame.

6. The wheel module of claim 4, further comprising: a hub bearing that couples the steering motor to the upper frame.

7. The wheel module of claim 6, further comprising: a first coupling that couples the hub bearing and the upper frame.

8. The wheel module of claim 1, further comprising: a second coupling that couples the wheel assembly and the knuckle.

9. The wheel module of claim 1, wherein the drive motor includes
a rotor coupled inside a rim of the road wheel, and
a stator coupled to the knuckle.

10. The wheel module of claim 9, wherein an axially open accommodation space is formed at a central portion of the stator, and the brake is accommodated in the accommodation space.

11. The wheel module of claim 10, wherein the brake is a drum brake.

12. The wheel module of claim 11, wherein the brake includes
a drum configured to rotate integrally with the rotor, and
a back plate that is coupled to the stator.

13. The wheel module of claim 12, the wheel assembly further includes a bracket that covers the accommodation space and is coupled to the stator, back plate and knuckle.

14. The wheel module of claim 13, wherein the bracket includes
a body coupled with the knuckle, and
a coupling extending from the body and coupled to the stator.

15. The wheel module of claim 13, wherein the wheel assembly includes a bearing including an inner ring to which the rotor of the drive motor and the drum of the brake are coupled, and an outer ring to which the back plate of the brake and the bracket are coupled.

16. The wheel module of claim 15, further comprising: a third coupling that connects the road wheel, the rotor of the drive motor, the drum of the brake, and the inner ring of the bearing.

17. The wheel module of claim 15, further comprising: a fourth coupling that connects the back plate of the brake, the bracket, and the outer ring of the bearing.

18. The wheel module of claim 9, further comprising: a coupling to which a connector of a wire assembly for supplying power to the stator is coupled, wherein the coupling is positioned in the stator.

19. The wheel module of claim 18, further comprising: a guide configured to guide a wire path of the wire assembly.

20. A vehicle comprising the wheel module according to claim 1.
